(19) United States
(12) Patent Application Publication
(10) Pub. No.: US 2024/0119111 A1
(43) Pub. Date: Apr. 11, 2024

(54) METHOD AND APPARATUS FOR PERFORMING TWO DIMENSION FAST FOURIER TRANSFORM FOR HOLOGRAM PROCESSING

(71) Applicant: Electronics and Telecommunications Research Institute, Daejeon (KR)

(72) Inventors: Won Ok KWON, Daejeon (KR); Sang Hoon CHEON, Daejeon (KR)

(73) Assignee: Electronics and Telecommunications Research Institute, Daejeon (KR)

(21) Appl. No.: 18/481,025

(22) Filed: Oct. 4, 2023

(30) Foreign Application Priority Data
Oct. 7, 2022 (KR) 10-2022-0128909
Aug. 29, 2023 (KR) 10-2023-0113663

(51) Int. Cl. G06F 17/14; G03H 1/08; G03H 1/16

(52) U.S. Cl. CPC G06F 17/142; G03H 1/0866; G03H 1/16; G03H 2226/02

(57) ABSTRACT

The present invention relates to a method and apparatus for performing two dimension fast fourier transform for hologram processing. A method for processing a hologram according to an embodiment of the present disclosure may comprise: generating complex data by multiplying the digital image by a random phase value; performing inverse fast fourier transform (IFFT) processing on the complex data; generating pattern information by multiplying a result of the IFFT processing by a quadrant phase; and processing the hologram based on the pattern information. Here, the IFFT processing may comprise a IFFT core operation that performs row-base IFFT and column-base IFFT on the complex data, and a single shift IFFT operation that applies a predefined rule to a result of one or more of the row-based IFFT or the column-based IFFT.

### CROSS-REFERENCE TO RELATED APPLICATIONS

This application claims the benefit of earlier filing date and right of priority to Korean Application No. 10-2022-0128909, filed on Oct. 7, 2022, and Korean Application No. 10-2023-0113663, filed on Aug. 29, 2023, the contents of which are all hereby incorporated by reference herein in their entirety.

### TECHNICAL FIELD

The present disclosure relates to a method and apparatus for performing a two-dimensional (2D) Fast Fourier Transform (FFT) for hologram processing.

### BACKGROUND

In order to convert a two-dimensional (2D) digital image into a hologram, 2D Fast Fourier Transform (FFT) may be required.

In this regard, shift-FFT may be performed prior to performing the corresponding FFT. Through this, rearrangement of the Fourier transform may be performed by moving the zero frequency component to the middle of the arrangement. Additionally, after performing the FFT, the Fourier transform may be rearranged into the original arrangement by performing the shift FFT again.

However, when implementing such a shift FFT in hardware, memory input and output are required. As a result, a large number of delay times may occur and the hologram processing speed may decrease.

### SUMMARY

The technical object of the present disclosure is to provide a method and apparatus for performing a two-dimensional fast Fourier transform (2D FFT) for hologram processing.

The technical object of the present disclosure is to provide a method and apparatus for performing 2D FFT processing for high-speed digital hologram calculation, which may produce the same effect even if the shift FFT process is removed, when processing FFT for a 2D image.

A technical object of the present disclosure is to provide a method and apparatus for performing 2D FFT processing capable of minimizing memory movement by removing a shift FFT process when processing FFT for a 2D image.

The technical objects to be achieved by the present disclosure are not limited to the above-described technical objects, and other technical objects which are not described herein will be clearly understood by those skilled in the pertinent art from the following description.

A method for processing a hologram according to an aspect of the present disclosure may comprise: generating complex data by multiplying the digital image by a random phase value; performing inverse fast fourier transform (IFFT) processing on the complex data; generating pattern information by multiplying a result of the IFFT processing by a quadrant phase; and processing the hologram based on the pattern information. Here, the IFFT processing may comprise a IFFT core operation that performs row-base IFFT and column-base IFFT on the complex data, and a single shift IFFT operation that applies a predefined rule to a result of one or more of the row-based IFFT or the column-based IFFT.

An apparatus for processing a hologram according to an additional aspect of the present disclosure may comprise a processor and a memory, and wherein the processor is configured to: generate complex data by multiplying the digital image by a random phase value; perform inverse fast fourier transform (IFFT) processing on the complex data; generate pattern information by multiplying a result of the IFFT processing by a quadrant phase; and process the hologram based on the pattern information. Here, the IFFT processing may comprise a IFFT core operation that performs row-base IFFT and column-base IFFT on the complex data, and a single shift IFFT operation that applies a predefined rule to a result of one or more of the row-based IFFT or the column-based IFFT.

One or more non-transitory computer readable media storing one or more instructions according to an additional aspect of the present disclosure, wherein the one or more instructions may be executed by one or more processors and control an apparatus for processing hologram to: generate complex data by multiplying the digital image by a random phase value; perform inverse fast fourier transform (IFFT) processing on the complex data; generate pattern information by multiplying a result of the IFFT processing by a quadrant phase; and process the hologram based on the pattern information. Here, the IFFT processing may comprise a IFFT core operation that performs row-base IFFT and column-base IFFT on the complex data, and a single shift IFFT operation that applies a predefined rule to a result of one or more of the row-based IFFT or the column-based IFFT.

In various aspects of the present disclosure, the predefined rule may be defined to multiply an even row or column by a first value and multiply an odd row or column by a second value. Here, the first value may correspond to −1, and the second value may correspond to 1.

In Addition, in various aspects of the present disclosure, the single shift IFFT operation may correspond to an operation of multiplying even-numbered columns by −1 and multiplying odd-numbered columns by 1, when the single shift IFFT operation is performed on a row basis.

In Addition, in various aspects of the present disclosure, the single shift IFFT operation may correspond to an operation of multiplying even-numbered rows by −1 and multiplying odd-numbered rows by 1, when the single shift IFFT operation is performed on a column basis.

In Addition, in various aspects of the present disclosure, the processing of the hologram may be based on a first memory-related operation and a second memory-related operation. At this time, the first memory-related operation may correspond to a memory write operation for a result of the row-based IFFT and the second memory-related operation may correspond to a memory read operation for performing the column-based IFFT. Alternatively, the first memory-related operation may correspond to a memory write operation for a result of the column-based IFFT and the second memory-related operation may correspond to a memory read operation for performing the row-based IFFT. In this regard, the first memory-related operation and the second memory-related operation may be associated with the IFFT core operation.

In Addition, in various aspects of the present disclosure, the digital image may correspond to a 2-dimensional digital image, and the complex data may be generated in the form of a complex matrix

In Addition, in various aspects of the present disclosure, the single shift IFFT operation may be based on streaming processing by a pre-configured code without a memory-related operation.

According to the present disclosure, a method and apparatus for performing a two-dimensional fast Fourier transform (2D FFT) for hologram processing may be provided.

According to the present disclosure, a method and apparatus for performing 2D FFT processing for high-speed digital hologram calculation, which may produce the same effect even if the shift FFT process is removed, when FFT processing for a 2D image, may be provided.

According to the present disclosure, a method and apparatus for performing 2D FFT processing capable of minimizing memory movement by removing a shift FFT process in FFT processing for a 2D image may be provided.

According to the present disclosure, memory transactions may be reduced by removing shift FFTs from a 2D FFT/IFFT processing structure, and based on this, real-time computer generated holography (CGH) processing speed may be improved.

Effects achievable by the present disclosure are not limited to the above-described effects, and other effects which are not described herein may be clearly understood by those skilled in the pertinent art from the following description.

### BRIEF DESCRIPTION OF THE DRAWINGS

FIG. 1 illustrates a block diagram of an operation of processing a digital image into a hologram of real-time hardware according to an existing method.

FIG. 2 illustrates an existing shift IFFT process.

FIG. 3 illustrates a hardware block diagram designed from the perspective of a memory transaction according to an existing method.

FIG. 4 illustrates a block diagram of an operation of processing a digital image into a hologram of real-time hardware according to an embodiment of the present disclosure.

FIGS. 5A, 5B, and 5C illustrate simulation results for the case of performing shift IFFT and 2D IFFT and the case of performing only 2D IFFT.

DIG. 6 illustrates a hardware block diagram designed from a memory transaction perspective according to an embodiment of the present disclosure.

FIG. 7 illustrates an operation flowchart of a method of processing a digital image into a hologram of real-time hardware according to an embodiment of the present disclosure.

FIG. 8 is a block diagram illustrating an apparatus according to an embodiment of the present disclosure.

### DETAILED DESCRIPTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

When implementing digital holograms (e.g., computer generated holography (CGH), etc.) with real-time hardware, a two-dimensional digital fast fourier transform (DFFT) may be used in mathematical operations such as an angular spectrum method (ASM) based on scalar diffraction theory or fresnel diffraction.

Hereinafter, in the present disclosure, for clarity of explanation, the above-described DFFT is referred to as FFT.

In this regard, for hologram processing, a fringe pattern transmitted to the hologram display device needs to be calculated.

An equation for calculating the fringe pattern may be expressed as in Equation 1 below.

Fringe Pattern=Quadrant Phase*2D IFFT(Input Image*Random Phase) [Equation 1]

Referring to Equation 1, after performing 2D IFFT (Inverse FFT) on the result of multiplying the input image and the random phase value, the fringe pattern may be calculated/output by multiplying the quadrant phase to the corresponding performance result. Here, the quadrant phase may correspond to focal length information.

In general, a fringe pattern acquired by real-time digital hologram generating hardware may be transmitted to a hologram display device (e.g., a spatial light modulator (SLM)) and reproduced as a hologram.

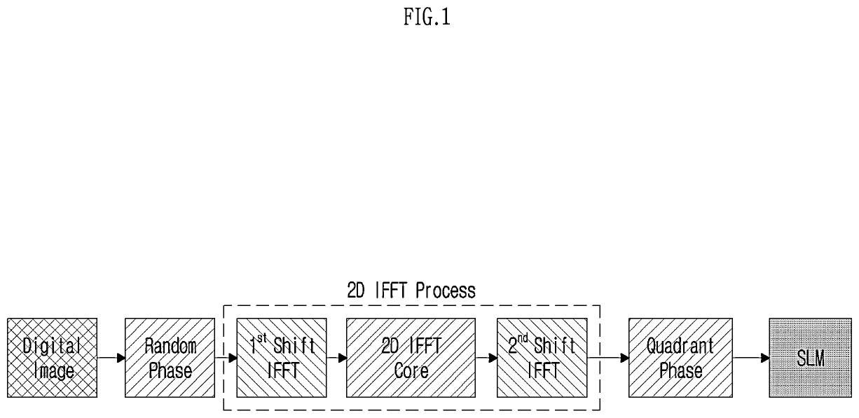

FIG. 1 illustrates a block diagram of an operation of processing a digital image into a hologram of real-time hardware according to an existing method.

For example, the block diagram illustrated in FIG. 1 may correspond to a hardware block diagram for implementing Equation 1 described above.

First, after multiplying a 2D digital image input by a random phase value, 2D IFFT processing may be performed. Here, the 2D IFFT processing may consist of a 2D IFFT core and two shift IFFTs.

Specifically, 2D IFFT processing may be performed in the order of [first shift IFFT, 2D IFFT core, second shift IFFT] for the result obtained by multiplying the random phase value.

A fringe pattern may be generated/output by multiplying the result of 2D IFFT processing by a quadrant phase, the corresponding fringe pattern may be transmitted/input to a hologram display device (e.g., SLM) for hologram reproduction.

In this regard, the shift IFFT may be a process for locating a zero frequency component to the center before performing the IFFT.

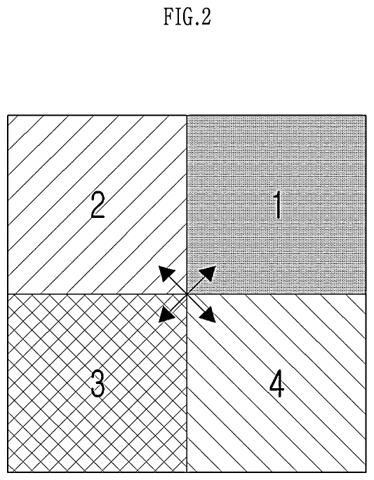

FIG. 2 illustrates a conventional shift IFFT process.

Referring to FIG. 2, the purpose of the shift IFFT is to center a zero frequency component before performing the IFFT.

For example, as illustrated in FIG. 2, in the case of shift IFFT for a 2D image, data exchange between the first quadrant and third quadrant may be performed in the center, and data exchange between the second quadrant and fourth quadrant may be performed.

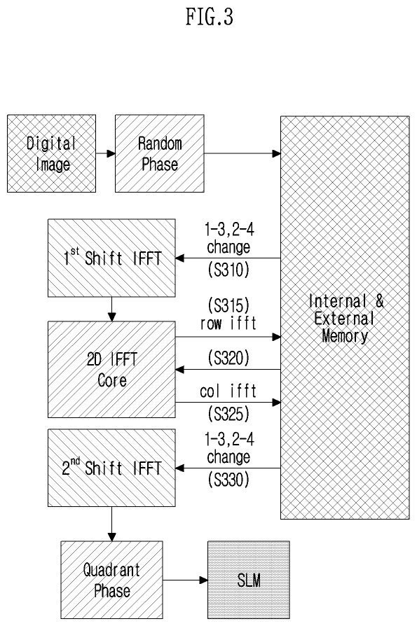

FIG. 3 illustrates a hardware block diagram designed from the perspective of a memory transaction according to an existing method.

For example, the block diagram shown in FIG. 3 may correspond to a hardware block diagram designed from a memory transaction perspective when hardware is designed based on the data flow in FIG. 1 described above.

Complex data obtained by multiplying a digital image by a random phase value may be stored in an internal/external memory (S305).

After a read operation on the memory, a first shift IFFT operation may be performed (S310). For example, as described above with reference to FIG. 2, data exchange between the first quadrant and the third quadrant and data exchange between the second quadrant and the fourth quadrant may be performed with respect to the complex number data stored in the memory.

Regarding the 2D IFFT core operation, row IFFT may be performed, and after the row IFFT is completed, a write operation to memory may be performed (S315).

Additionally, a read operation to memory may be performed to perform column IFFT (S320), and a write operation to memory may be performed after column IFFT is performed (S325).

Thereafter, a read operation (S330) may be performed on the memory to perform the second shift IFFT operation.

Thereafter, the fringe pattern may be calculated by multiplying the result of the second shift IFFT operation by a quadrant phase, and the fringe pattern may be transmitted to a hologram display device (e.g., SLM).

In the case of the procedure described in FIG. 3, a read/write operation to the memory must be performed 6 times. That is, six memory-related operations are required, which is closely related to real-time digital hologram data processing speed.

That is, it may be seen that the existing digital hologram hardware generates 6 memory transactions for 2D IFFT processing.

As the number of memory transactions increases, a problem in which processing speed decreases in reproducing holograms requiring real-time processing may occur.

Therefore, the present disclosure proposes a method for improving real-time digital hologram data processing speed by reducing the number of memory transactions.

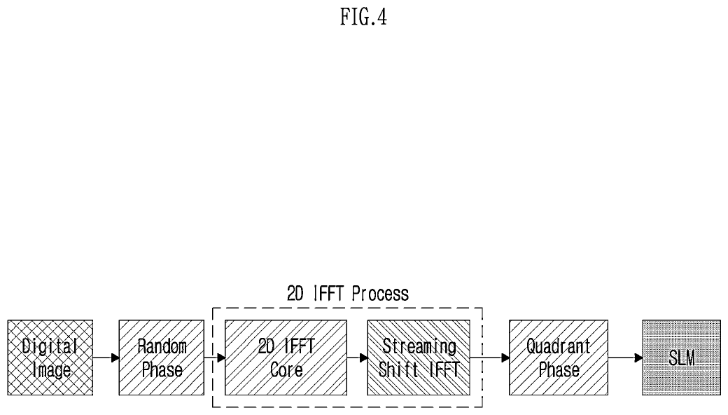

FIG. 4 illustrates a block diagram of an operation of processing a digital image into a hologram of real-time hardware according to an embodiment of the present disclosure.

In contrast to the existing method described in FIG. 1, in the case of the method according to the embodiment of the present disclosure, the first shift IFFT block and the second shift IFFT block may be removed and a streaming shift IFFT block may be added in the 2D IFFT processing.

That is, according to an embodiment of the present disclosure, Shift IFFT blocks performed before and after the 2D IFFT core block in the existing 2D IFFT process is removed, a streaming shift IFFT block is added after the 2D IFFT core block.

When implementing/reproducing a hologram, a first shift IFFT, that is, a first shift IFFT operation may play an important role in restoring a digital hologram (e.g., CGH). However, a second shift IFFT, that is, a second shift IFFT has a small effect on the hologram image quality, it may be removable.

Hereinafter, a method of processing the first shift IFFT operation will be described.

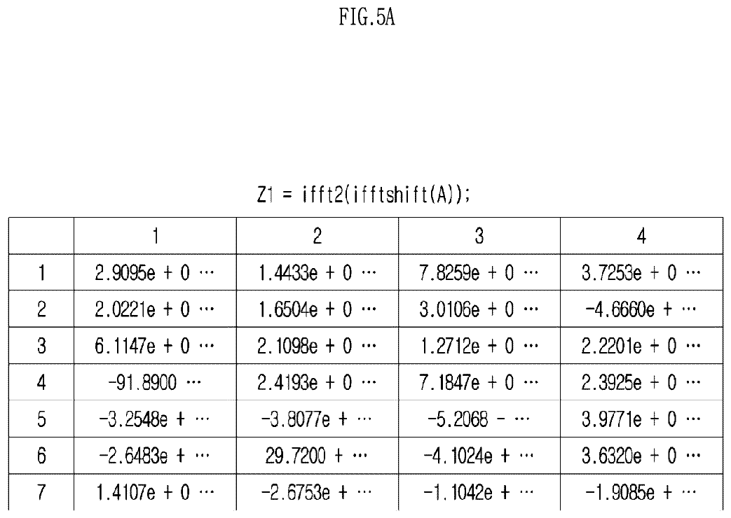

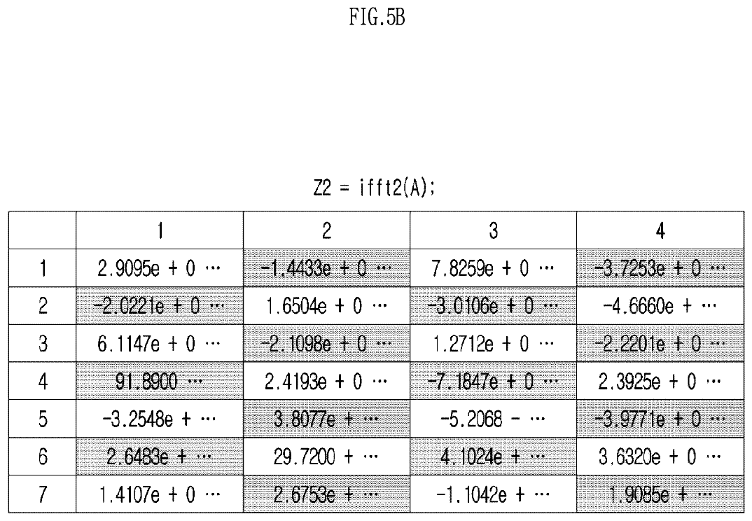

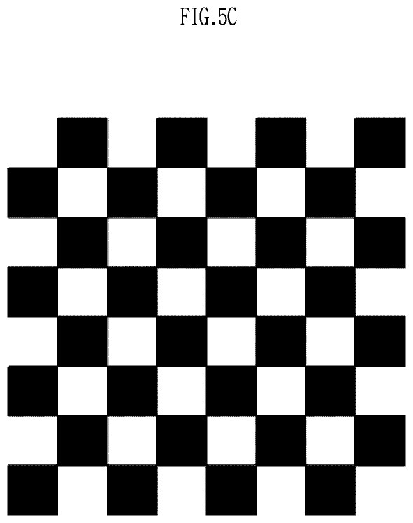

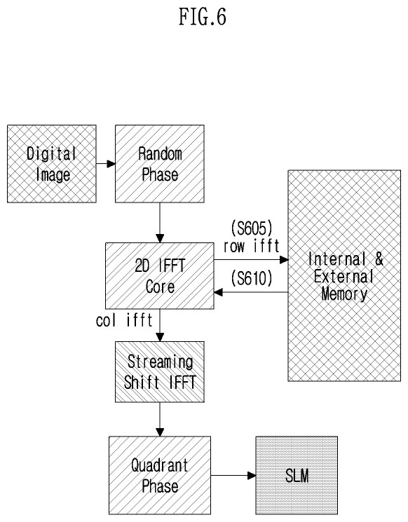

FIGS. 5A, 5B, and 5C illustrate simulation results for the case of performing shift IFFT and 2D IFFT and the case of performing only 2D IFFT.

FIG. 5A illustrates the result of MATLAB simulation when shift IFFT and 2D IFFT are performed on an arbitrary complex matrix.

On the other hand, FIG. 5B illustrates the result of MATLAB simulation when only 2D IFFT is performed on an arbitrary complex matrix.

Referring to FIG. 5A and FIG. 5B, the result of performing shift IFFT and 2D IFFT on the arbitrary complex matrix may be the same as a result of multiplying a result of performing only 2D IFFT by (−1) or (1) as a lattice structure.

This may be expressed as in Equation 2 below.

Z=ifft2(ifftshift(A))=ifft2(A)*(+1,−1) [Equation 2]

In Equation 2, ifft2( ) represents 2D IFFT processing, and ifftshift( ) represents shift IFFT processing.

For example, a method of multiplying the lattice structure illustrated in FIG. 5C by considering the rows and columns of the result of performing only the 2D IFFT may be considered. In FIG. 5C, a black portion may correspond to (−1) and a white portion may correspond to (1).

Specifically, on a row-by-row basis, it may be defined/configured so that even columns of the result of performing only 2D IFFT are multiplied by −1, and odd columns of the result of performing only 2D IFFT are multiplied by 1. Additionally, on a column-by-column basis, it may be defined/configured so that even rows of the result of performing only 2D IFFT are multiplied by −1, and odd rows of the result of performing only 2D IFFT are multiplied by 1. For example, the method as described above may be expressed as shown in Table 1 below.

TABLE 1

```
if (row data input)
  if(even column)
    output data < = − input data;
  else
    output data < = input data;
else // column data input
  if(even row)
    output data < = − input data;
  else
    output data < = input data;
```

In this regard, the streaming shift IFFT block illustrated in FIG. 4 may be configured/defined to perform a multiplication function in consideration of rows and columns as described above with reference to FIG. 5.

In the case of the proposed method described above in this disclosure, regardless of whether the result of the 2D IFFT core is row data or column data, it has the advantage that it may be processed as a stream without read/write operations to memory. Based on this, the processing speed of real-time digital hologram data may be increased.

FIG. 6 illustrates a hardware block diagram designed from a memory transaction perspective according to an embodiment of the present disclosure.

For example, the block diagram illustrated in FIG. 6 may correspond to a hardware block diagram designed from a memory transaction perspective when hardware is designed based on the data flow in FIG. 4 described above.

Complex data obtained by multiplying a digital image by a random phase value may be transferred/input to the 2D IFFT core.

Regarding the 2D IFFT core operation, row IFFT may be performed, and after the row IFFT is completed, a write operation to memory may be performed (S605).

Additionally, a read operation on memory may be performed to perform column IFFT (S320).

After column IFFT is performed, the result may be transferred/input to streaming shift IFFT, accordingly, streaming processing such as the code in Table 1 described above may be performed. Through this, 2D IFFT processing may be performed at high speed.

Then, the fringe pattern may be calculated by multiplying the result of the streaming shift IFFT operation by a quadrant phase, and the corresponding fringe pattern may be transferred to a hologram display device (e.g., SLM).

That is, it may be seen that the digital hologram hardware according to the proposed method of the present disclosure generates only two memory transactions for 2D IFFT processing. Through this, it may be confirmed that the effect of reducing the number of times is significant compared to the six memory transactions described in FIG. 3.

As the number of memory transactions decreases in this way, processing speed may increase in reproducing holograms requiring real-time processing. That is, according to the proposed method of the present disclosure, digital hologram (e.g., CGH) processing of a digital image may be performed at high speed.

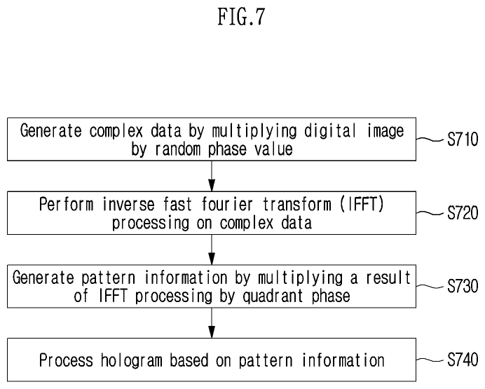

FIG. 7 illustrates an operation flowchart of a method of processing a digital image into a hologram of real-time hardware according to an embodiment of the present disclosure.

The operation flow chart of FIG. 7 may be based on the hologram processing method described through FIGS. 1 to 6 in the present disclosure.

In step S710, complex data may be generated by multiplying the digital image by a random phase value.

For example, the digital image may correspond to a 2-dimensional digital image, and complex data may be generated in the form of a complex matrix.

In step S720, inverse fast fourier transform (IFFT) processing may be performed on the complex data.

Here, the IFFT processing may comprise a IFFT core operation for performing row-base IFFT and column-base IFFT on the complex data, and a single shift IFFT operation that applies a predefined rule to the result of one or more of the row-based IFFT or the column-based IFFT, etc.

For example, a predefined rule may be defined to multiply a first value for an even row or column and multiply a second value for an odd row or column. Here, the first value may correspond to −1, and the second value may correspond to 1.

As a specific example, when the above-described single shift IFFT operation is performed on a row basis, the corresponding shift IFFT operation may correspond to an operation of multiplying even-numbered columns by −1 and multiplying odd-numbered columns by 1.

As a specific example, when the above-described single shift IFFT operation is performed on a column basis, the corresponding single shift IFFT operation may correspond to an operation of multiplying even-numbered rows by −1 and multiplying odd-numbered rows by 1.

In this regard, the single shift IFFT operation may be based on streaming processing by a pre-configured code without a memory-related operation.

In step S730, pattern information (e.g., fringe pattern information) may be generated by multiplying the FFT processing result in step S720 by a quadrant phase value.

Then, in step S740, a hologram may be processed/implemented/generated based on the generated pattern information.

For example, the aforementioned hologram processing may be based on a first memory-related operation and a second memory-related operation. Here, the first memory-related operation may correspond to a memory write operation for the result of the row-based IFFT, and the second memory-related operation may correspond to a memory read operation for performing the column-based IFFT. Alternatively, the first memory-related operation may correspond to a memory write operation for the result of the column-based IFFT, and the second memory-related operation may correspond to a memory read operation for performing the row-based IFFT.

In this regard, the first memory-related operation and the second memory-related operation may be associated with the aforementioned IFFT core operation.

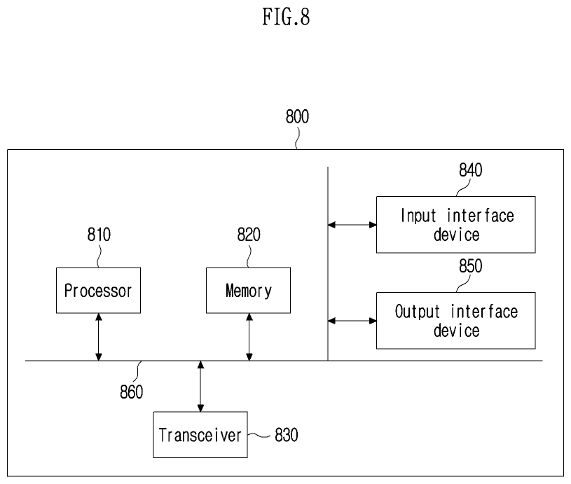

FIG. 8 is a block diagram illustrating an apparatus according to an embodiment of the present disclosure.

Referring to FIG. 8, a device 800 may represent a device in which the method of implementing/processing a digital image into a real-time digital hologram described in the present disclosure is implemented.

For example, the device 800 may generally support/perform a function to multiply a random phase value, read/write function for a memory; operation function in 2D IFFT core (e.g., row IFFT, column IFFT, etc.); streaming shift IFFT operation function; function to multiply a quadrant phase, and a transfer function to a hologram display device.

The device 800 may include at least one of a processor 810, a memory 820, a transceiver 830, an input interface device 840, and an output interface device 850. Each of the components may be connected by a common bus 860 to communicate with each other. In addition, each of the components may be connected through a separate interface or a separate bus centering on the processor 810 instead of the common bus 860.

The processor 810 may be implemented in various types such as an application processor (AP), a central processing unit (CPU), a graphic processing unit (GPU), etc., and may be any semiconductor device that executes a command stored in the memory 820. The processor 810 may execute a program command stored in the memory 820. The processor 810 may be configured to implement a method/system for implementing/processing a digital image into a real-time digital hologram based on FIGS. 1 to 7 described above.

And/or, the processor 810 may store a program command for implementing at least one function for the corresponding modules in the memory 820 and may control the operation described based on FIGS. 1 to 7 to be performed.

The memory 820 may include various types of volatile or non-volatile storage media. For example, the memory 820 may include read-only memory (ROM) and random access memory (RAM). In an embodiment of the present disclosure, the memory 820 may be located inside or outside the processor 810, and the memory 820 may be connected to the processor 810 through various known means.

The transceiver 830 may perform a function of transmitting and receiving data processed/to be processed by the processor 810 with an external device and/or an external system.

The input interface device 840 is configured to provide data to the processor 810.

The output interface device 850 is configured to output data from the processor 810.

According to the present disclosure, a method and apparatus for performing a two-dimensional fast Fourier transform (2D FFT) for hologram processing may be provided.

According to the present disclosure, a method and apparatus for performing 2D FFT processing for high-speed digital hologram calculation, which may produce the same effect even if the shift FFT process is removed, when FFT processing for a 2D image, may be provided.

According to the present disclosure, a method and apparatus for performing 2D FFT processing capable of minimizing memory movement by removing a shift FFT process in FFT processing for a 2D image may be provided.

According to the present disclosure, memory transactions may be reduced by removing shift FFTs from a 2D FFT/IFFT processing structure, and based on this, real-time computer generated holograpy (CGH) processing speed may be improved.

Additionally, the proposed method in the present disclosure may be extended and applied to various methods/hardware implementing/processing 2D FFT or 2D IFFT as well as methods/hardware for implementing/processing holograms for digital images.

The components described in the example embodiments may be implemented by hardware components including, for example, at least one digital signal processor (DSP), a processor, a controller, an application-specific integrated circuit (ASIC), a programmable logic element, such as an FPGA, GPU other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers.

A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, it is intended that this disclosure embrace all other substitutions, modifications and variations belong within the scope of the following claims.

What is claimed is:

1. A method of processing hologram, the method comprising:
generating complex data by multiplying the digital image by a random phase value;
performing inverse fast fourier transform (IFFT) processing on the complex data;
generating pattern information by multiplying a result of the IFFT processing by a quadrant phase; and
processing the hologram based on the pattern information,
wherein the IFFT processing comprises a IFFT core operation that performs row-base IFFT and column-base IFFT on the complex data, and a single shift IFFT operation that applies a predefined rule to a result of one or more of the row-based IFFT or the column-based IFFT.

2. The method of claim 1,
wherein the predefined rule is defined to multiply an even row or column by a first value and multiply an odd row or column by a second value.

3. The method of claim 2,
wherein the first value corresponds to −1, and the second value corresponds to 1.

4. The method of claim 1,
wherein the single shift IFFT operation corresponds to an operation of multiplying even-numbered columns by −1 and multiplying odd-numbered columns by 1, when the single shift IFFT operation is performed on a row basis.

5. The method of claim 1,
wherein the single shift IFFT operation corresponds to an operation of multiplying even-numbered rows by −1 and multiplying odd-numbered rows by 1, when the single shift IFFT operation is performed on a column basis.

6. The method of claim 1,
wherein the processing of the hologram is based on a first memory-related operation and a second memory-related operation, and
wherein the first memory-related operation corresponds to a memory write operation for a result of the row-based IFFT and the second memory-related operation corresponds to a memory read operation for performing the column-based IFFT, or
wherein the first memory-related operation corresponds to a memory write operation for a result of the column-based IFFT and the second memory-related operation corresponds to a memory read operation for performing the row-based IFFT.

7. The method of claim 6,
wherein the first memory-related operation and the second memory-related operation are associated with the IFFT core operation.

8. The method of claim 1,
wherein the digital image corresponds to a 2-dimensional digital image, and
wherein the complex data is generated in the form of a complex matrix.

9. The method of claim 1,
wherein the single shift IFFT operation is based on streaming processing by a pre-configured code without a memory-related operation.

10. An apparatus for processing hologram, the apparatus comprising:
a processor and a memory,
wherein the processor is configured to:
generate complex data by multiplying the digital image by a random phase value;
perform inverse fast fourier transform (IFFT) processing on the complex data;
generate pattern information by multiplying a result of the IFFT processing by a quadrant phase; and
process the hologram based on the pattern information,
wherein the IFFT processing comprises a IFFT core operation that performs row-base IFFT and column-base IFFT on the complex data, and a single shift IFFT operation that applies a predefined rule to a result of one or more of the row-based IFFT or the column-based IFFT.

11. The apparatus of claim 10,
wherein the predefined rule is defined to multiply an even row or column by a first value and multiply an odd row or column by a second value.

12. The apparatus of claim 11,
wherein the first value corresponds to −1, and the second value corresponds to 1.

13. The apparatus of claim 10,
wherein the single shift IFFT operation corresponds to an operation of multiplying even-numbered columns by −1 and multiplying odd-numbered columns by 1, when the single shift IFFT operation is performed on a row basis.

14. The apparatus of claim 10,
wherein the single shift IFFT operation corresponds to an operation of multiplying even-numbered rows by −1 and multiplying odd-numbered rows by 1, when the single shift IFFT operation is performed on a column basis.

15. The apparatus of claim 10,
wherein the processing of the hologram is based on a first memory-related operation and a second memory-related operation, and
wherein the first memory-related operation corresponds to a memory write operation for a result of the row-based IFFT and the second memory-related operation corresponds to a memory read operation for performing the column-based IFFT, or
wherein the first memory-related operation corresponds to a memory write operation for a result of the column-based IFFT and the second memory-related operation corresponds to a memory read operation for performing the row-based IFFT.

16. The apparatus of claim 15,
wherein the first memory-related operation and the second memory-related operation are associated with the IFFT core operation.

17. The apparatus of claim 10,
wherein the digital image corresponds to a 2-dimensional digital image, and
wherein the complex data is generated in the form of a complex matrix.

18. The apparatus of claim 10,
wherein the single shift IFFT operation is based on streaming processing by a pre-configured code without a memory-related operation.

19. One or more non-transitory computer readable media storing one or more instructions,
wherein the one or more instructions are executed by one or more processors and control an apparatus for processing hologram to:
generate complex data by multiplying the digital image by a random phase value;
perform inverse fast fourier transform (IFFT) processing on the complex data;
generate pattern information by multiplying a result of the IFFT processing by a quadrant phase; and
process the hologram based on the pattern information,
wherein the IFFT processing comprises a IFFT core operation that performs row-base IFFT and column-base IFFT on the complex data, and a single shift IFFT operation that applies a predefined rule to a result of one or more of the row-based IFFT or the column-based IFFT.

20. The computer readable media of claim 19,
wherein the predefined rule is defined to multiply an even row or column by a first value and multiply an odd row or column by a second value.
